(19) United States
(12) Patent Application Publication
(10) Pub. No.: US 2007/0012808 A1
(43) Pub. Date: Jan. 18, 2007

(54) Shredder safety device having emergency stop

(76) Inventor: Cheng-Chung Kao, SanChung City (TW)

Correspondence Address: David E. Dougherty;DENNISON, SCHULTZ, DOUGHERTY & MACDONALD, Suite 105, 1727 King Street, Alexandria, VA, 22314, US

(21) Appl. No.: 11/230,826

(22) Filed: Sep. 21, 2005

Related U.S. Application Data
(63) Continuation-in-part of application No. 11/182,765, filed on Jul. 18, 2005, now abandoned.

(51) Int. Cl. B02C 25/00

(52) U.S. Cl. 241/37.5

(57) ABSTRACT

A shredder safety device having emergency stop, including: at least one sensing component provided next to a shredder opening, the sensing component being electrically connected to a conventional tactile sensing circuit and a motor driving circuit, whereby when the sensing component comes into contact with the human body (finger), signals are generated to command shutdown of the motor driving circuit through the tactile sensing circuit, resulting in motor halt thereby preventing the human body (finger) from being pulled into the shredder opening and resulting in injuries.

### CROSS-REFERENCES TO RELATED APPLICATIONS

This patent application is a continuation-in-part (CIP) of a U.S. patent application Ser. No. 11/182,765 filed Jul. 18, 2005, and now pending. The content of the related patent application is incorporated herein for reference.

### STATEMENT REGARDING FEDERALLY SPONSORED RESEARCH OR DEVELOPMENT

Not Applicable

### DESCRIPTION

1. Field of Invention

This invention relates to paper shredders, particularly to one having an emergency stop capable of automatic shutdown when one's fingers come into contact with the shredder opening, so as to prevent the fingers from being pulled into the shredder opening thereby causing injuries.

2. Background

US Consumer Product Safety Commission; CPSC published the Paper Shredder Safety Alert published under CPSC Document # 5127 in May 2004. With reference to FIG. 1, the CPSC alerts family to be safe if they have a paper shredder. According to the document, from January 2000 through December 2003, CPSC received 31 reports involving finger amputations, lacerations, and other finger injuries from paper shredders. The majority of injuries were to young children, ages 14 months to 2 years old. Young children are interested in imitating adult activities. This puts children at risk of injury. Children may activate the shredder when an adult is not present. Injuries can occur even when an adult is supervising a child. Children's fingers can be pulled into the paper shredding mechanism if they don't let the paper go. Therefore, the CPSC offers the following safety tips when using a paper shredder:

1. Never allow children to operate paper shredders, even under adult supervision. Paper shredders can pull children's fingers into the shredder mechanism.

2. Place the paper shredder in an area less accessible to children.

3. Unplug the paper shredder power cord when not in use.

4. Do not place hands or fingers in the shredder.

5. Do not operate a paper shredder while wearing loose fitting clothing that may enter the shredder opening.

6. If wearing a tie or long necklace, use caution to keep these items away from the shredder opening.

### SUMMARY OF INVENTION

It is a primary object of this invention to provide a shredder safety device having emergency stop that is capable of automatic shutdown when one's fingers come into contact with the shredder opening, so as to prevent the fingers from being pulled into the shredder opening thereby causing injuries.

It is another object of this invention to provide a shredder safety device having emergency stop, such that one suddenly realizes that the paper to be fed into the shredder should nevertheless be preserved and intends to emergently stop the shredding operation, one may contact a sensing component by his finger to cause automatic shutdown and emergency stop of the shredder.

To achieve the above objects and to eliminate the possible risk that may be resulted from operating the conventional shredders, this invention discloses a shredder safety device having emergency stop, including: at least one sensing component provided next to a shredder opening, the sensing component being a conventional sheet metal or its equivalent such as conductative coatings, the sensing component being electrically connected to the conventional tactile sensing circuit and motor driving circuit, such that when the sensing component comes into contact with the human body (finger), signals would be generated to command shutdown of the motor driving circuit through the tactile sensing circuit, resulting in motor halt thereby preventing the human body (finger) from being pulled into the shredder opening and resulting in injuries.

### BRIEF DESCRIPTION OF THE DRAWINGS

These and other modifications and advantages will become even more apparent from the following detained description of a preferred embodiment of the invention and from the drawings in which:

FIG. 1 is a schematic view showing the alert announced by CPSC under Document #5127, Paper Shredder Safety Alert, preventing children from playing with paper shredders;

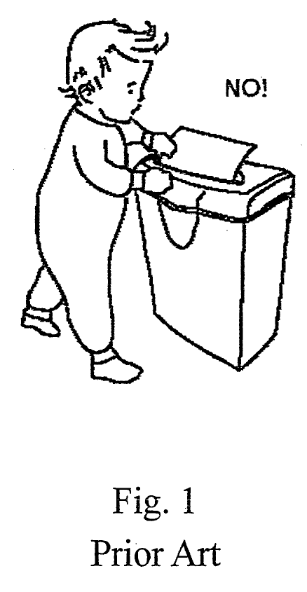

FIG. 2 is a structural schematic view illustrating where this invention using sheet metal as sensing component and is implemented in a shredder having an inclined shredder opening;

FIG. 3 is a structural schematic view illustrating where this invention using sheet metal as sensing component and is implemented in a shredder having a leveled shredder opening; and

FIG. 4 is a structural schematic view illustrating where this invention using conductative coatings as sensing component which is provided to a leading edge of the shredder opening.

FIG. 5 is a schematic diagram of a sensing component, sensing circuit, motor driving circuit and motor as used in the present invention.

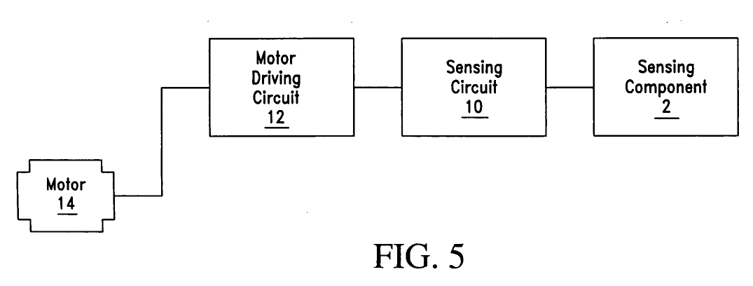

### DETAILED DESCRIPTION OF THE INVENTION (PREFERRED EMBODIMENTS)

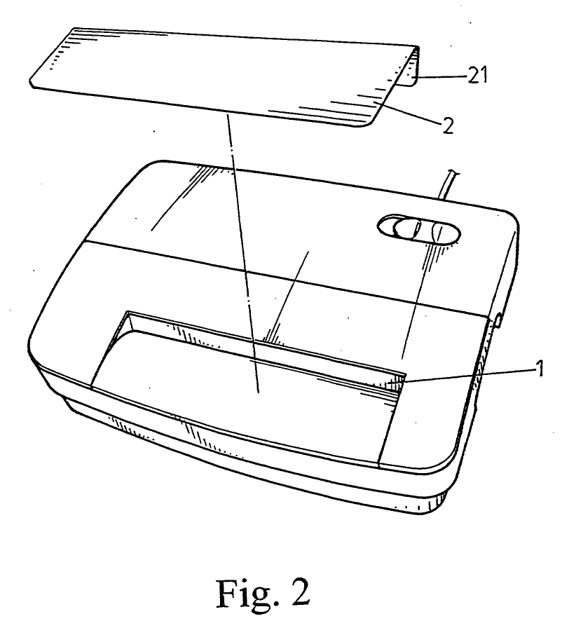

FIG. 2 is a structural schematic view illustrating where this invention is implemented in a shredder having an inclined shredder opening. As shown, the shredder opening 1 is of a semi-concealed configuration with an inclined opening. In this embodiment, a sensing component 2 made of a sheet metal is provided to a leading edge of the shredder opening 1. The sheet metal of component 2 bends downwards and towards the shredder opening 1 at an appropriate angle to form a bending portion 21. In the case where one's finger is pulled into the shredder opening 1 and eventually comes into contact with the bending portion 21, the finger is sensed by the sensing component 2 to ensure safety. The component 2 is electrically connected to a conventional tactile sensing circuit10 and a shredder motor driving circuit 12, such that when the component 2 senses contact of the finger, signals would be generated to command shutdown of the motor driving circuit 12 through the tactile sensing circuit 10, resulting in a motor 14 to halt thereby preventing the finger from being pulled into the shredder opening 1 and resulting in injuries.

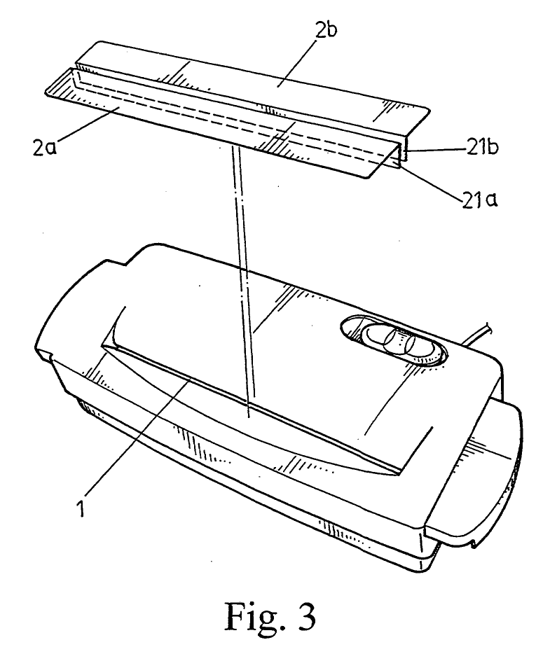

FIG. 3 illustrates a schematic drawing of a second embodiment of this invention, in which the shredder opening 1 is configured to an accessible leveled opening. In this embodiment, the sensing component including sheet metals 2a, 2b are provided to opposing sides of the accessible shredder opening 1. Similarly, the sheet metals 2a, 2b each bend downwards and towards the shredder opening 1 at an appropriate angle to form bending portions 21a, 21b. In the case where one's finger is pulled into the shredder opening 1 and eventually comes into contact with the bending portions 21a, 21b, the finger is sensed by the sensing component to ensure safety. The sheet metals 21a, 2b are each electrically connected to a conventional tactile sensing circuit and a shredder motor driving circuit (not shown), such that when the sheet metals 21a, 21b sense contact of the finger, signals would be generated to command shutdown of the motor driving circuit through the tactile sensing circuit, resulting in motor halt thereby preventing the human body (finger) from being pulled into the shredder opening 1 and resulting in injuries.

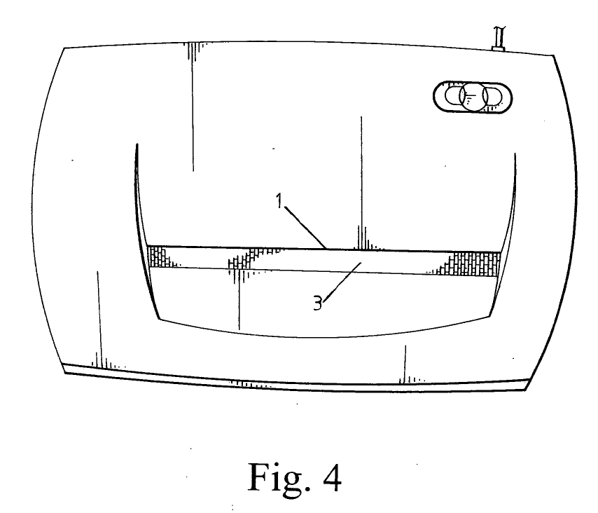

FIG. 4 illustrates a schematic drawing of a third embodiment of this invention, in which no matter the shredder opening 1 is configured to an accessible leveled opening as described in the second embodiment or the shredder opening 1 is of a semi-concealed configuration with an inclined opening as described in the first embodiment. In this embodiment, the sensing component is replaced from sheet metal(s) to conductative coatings 3. Similarly, in the case where one's finger is pulled into the shredder opening 1 and eventually comes into contact with the conductative coatings 3, the finger is sensed by the sensing component to ensure safety. The conductative coatings 3 being electrically connected to a conventional tactile sensing circuit and a shredder motor driving circuit (not shown), such that when the conductative coatings 3 sense contact of the finger, signals would be generated to command shutdown of the motor driving circuit through the tactile sensing circuit, resulting in motor halt thereby preventing the human body (finger) from being pulled into the shredder opening 1 and resulting in injuries.

By adopting the above tactile sensing component that would command the shutdown of the motor driving circuit, not only one's finger can be prevent from being pulled into the shredder opening and resulting in injuries, the shredding operation may also be emergently stopped by contacting the sensing component to result in motor halt.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. A shredder having a shredder opening and a safety device having an emergency stop and, including: one sensing component disposed next to said shredder opening, a tactile sensing circuit, a motor driving circuit and a motor, and said sensing component electrically connected to said tactile sensing circuit and said tactile sensing circuit connected to said sensing circuit and said motor driving circuit, whereby when the sensing component comes into contact with a finger signals are generated to command shutdown of the motor driving circuit through said tactile sensing circuit, resulting in motor to halt thereby preventing the finger from being pulled into said shredder opening and resulting in injuries.

2. The shredder safety device having emergency stop of claim 1, wherein the sensing component is a sheet metal.

3. The shredder safety device having emergency stop of claim 2, wherein the sheet metal bends downwards and towards the shredder opening at an appropriate angel to from a bending portion.

4. The shredder safety device having emergency stop of claim 1, wherein the sensing component is conductative coatings.
